(19) United States
(12) Patent Application Publication
(10) Pub. No.: US 2009/0099947 A1
(43) Pub. Date: Apr. 16, 2009

(54) System and method for electronic funds payment

(75) Inventors: Steve Boehm, Charlotte, NC (US); Kelly Jurgens, Charlotte, NC (US); Dean Nolan, Charlotte, NC (US); David Bellinger, Charlotte, NC (US)

Correspondence Address: K&L Gates LLP, 214 N. TRYON STREET, HEARST TOWER, 47TH FLOOR, CHARLOTTE, NC, 28202, US

(73) Assignee: Wachovia Corporation, Charlotte, NC (US)

(21) Appl. No.: 11/974,695

(22) Filed: Oct. 16, 2007

(51) Int. Cl. G06Q 20/00

(52) U.S. Cl. 705/35

(57) ABSTRACT

A system and method for electronic payment in a computer payment network. The system comprises a choice engine communicatively connected to a computer payment network for electronically providing a purchaser with an option to select a funding source for a purchase. The funding source is selected pre-purchase, during purchase, post-purchase, or a combination thereof. The founding source is a liquid funding account or a credit vehicle. The purchaser may use a universal payment device to make the purchase.

### FIELD OF THE INVENTION

The present invention relates to a system and method for electronic funds payment.

### BACKGROUND OF THE INVENTION

Payment cards such as credit cards and debit cards have gained global acceptance as forms of electronic funds payment. Cash and check purchases are declining as consumers and merchants prefer electronic funds payments. Thus, an entire industry has developed around electronic funds payment and transfer.

In many markets such as the United States, the credit card market is believed to be saturated. Households in the United States average more than six general purpose credit cards and charge cards and a not insignificant amount of debt. Nevertheless, although the credit card market is arguably saturated, it is reported as being highly profitable and presently generating over $100 billion dollars in revenue annually.

Additionally, the debit card market is a growing market. The debit card market in the United States is also believed to be highly saturated, and it is reported that nearly 90% of households have a debit card linked to their bank account. Debit cards have not gained as consistent use as credit cards in the past but since 2005 are reportedly beginning to exceed the number of credit card transactions. Thus, the market for debit cards as payment cards is anticipated to grow. Therefore, both credit cards and debit cards provide access to payment card networks in a growing electronic funds payment industry.

The current industry practice with respect to electronic funds payment is best shown by referring now to FIG. 1 which is a flow diagram illustrating the known process for purchaser payment. According to FIG. 1, a purchaser must carry multiple forms of payment to allow the purchaser to choose which source of funding source will be used to pay for a given purchase. As is the current practice in the industry, a line of communication must be made between each form of payment used by a purchaser and each source of funds via an existing computer payment network or system. This occurs for each transaction. Thus, each transaction may require a different form of payment, a different point of sale (POS) terminal, a different computer payment system, a different source of funds, or a combination thereof. Thus, for multiple transactions, there are numerous communications and many transaction processing steps that must occur.

FIG. 2A is a flow diagram which expands upon the existing computer payment system infrastructure of FIG. 1 and is an example of a credit or debit route for a VISA or MasterCard transaction. The parties to an authorization and a settlement VISA or MasterCard transaction typically comprise a purchaser, a merchant, an optional International Sales Organization (ISO), a merchant acquirer, VISA/MasterCard, an optional issuer processor, an issuer, and a source of funds. A series of events shown in FIG. 2A has to occur for each VISA/MasterCard transaction using a VISA/MasterCard payment card used at a merchant point of sale (POS) terminal. Among the disadvantages associated with such a system is that it requires purchasers to carry multiple payment devices in order to achieve financial control and funding source flexibility at the POS, limits the funding source information available to a purchaser during a purchase, increases system complexity for merchants and purchasers as a result of requiring both to utilize multiple payment devices at the POS, increases risk of fraud by not allowing the purchaser to approve transactions before they settle to the purchaser's account, provides less security by virtue of having to carry multiple forms of payment and to allow for multiple processing, and lacks simplicity and convenience as a unique “device to funding source” transaction route must occur for every payment.

FIG. 2B is a flow diagram illustrating the current industry process for authorization of a VISA/MasterCard transaction. FIG. 2C is a flow diagram illustrating the current industry process for settlement of a VISA/MasterCard transaction. In the authorization process, as shown in FIG. 2B, a purchaser uses a VISA/MasterCard payment card to pay for goods or services at a merchant point of sale (POS) terminal, the transaction is captured by an ISO or a merchant acquirer. An ISO is an independent sales organization that is a reseller of acquirer services. A merchant acquirer is typically a bank member of a card network that collects payments on behalf of a merchant. The transaction is then routed by the merchant acquirer to the computer payment network which, in this example, is VISA or MasterCard. The transaction is then routed to an issuer. The issuer is typically a bank member of a card network that issues network approved payment devices. The issuer may approve or deny a transaction based upon the presence of fraudulent activity or upon funds availability. The funds availability is communicatively connected to a source of funds as shown in FIG. 2A. The transaction is either approved or declined and returned to the merchant POS terminal.

With respect to the process for settlement shown in FIG. 2C, VISA/MasterCard facilitates settlement between the merchant acquirer and issuer. The merchant acquirer then settles with the merchant. The issuer then settles with the purchaser using the funding source which is linked to the VISA MasterCard payment card.

Thus, the above process is known and currently occurs for each payment transaction. The process creates inefficiencies for purchasers and merchants. Thus, there is a need to make the process more efficient for purchasers as well as merchants in the electronic payment process.

### SUMMARY OF THE INVENTION

The present invention is for a system and method for electronic payment in a computer payment network. The system comprises a choice engine communicatively connected to a computer payment network for electronically providing a purchaser with an option to select a funding source for a purchase. The funding source is selected pre-purchase, during purchase, post-purchase, or a combination thereof. The founding source is a liquid funding account or a credit vehicle. The purchaser may use a universal payment device to make the purchase.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow diagram illustrating the known process for purchaser payments.

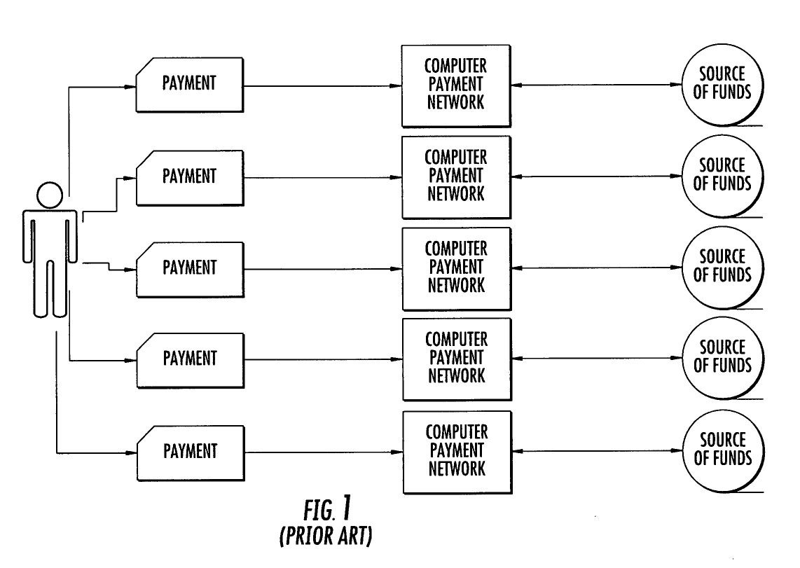

FIG. 2A is a flow diagram which expands upon the existing computer payment system infrastructure of FIG. 1 and is an example of a credit or debit route for a VISA or MasterCard transaction.

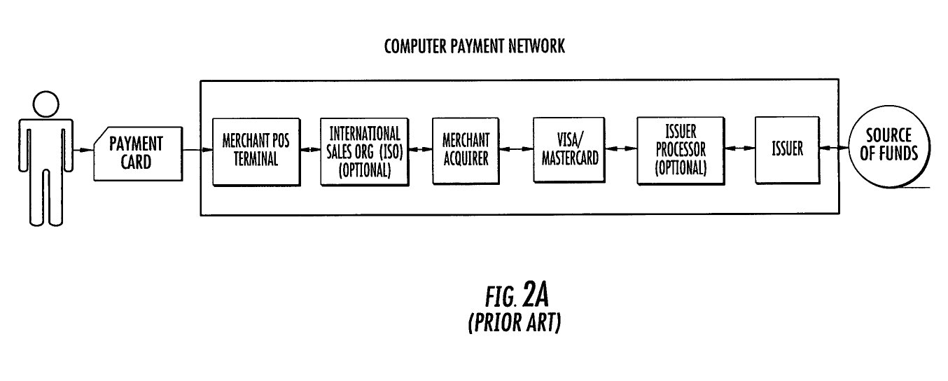

FIG. 2B is a flow diagram of the current industry process for authorization of a VISA/MasterCard transaction.

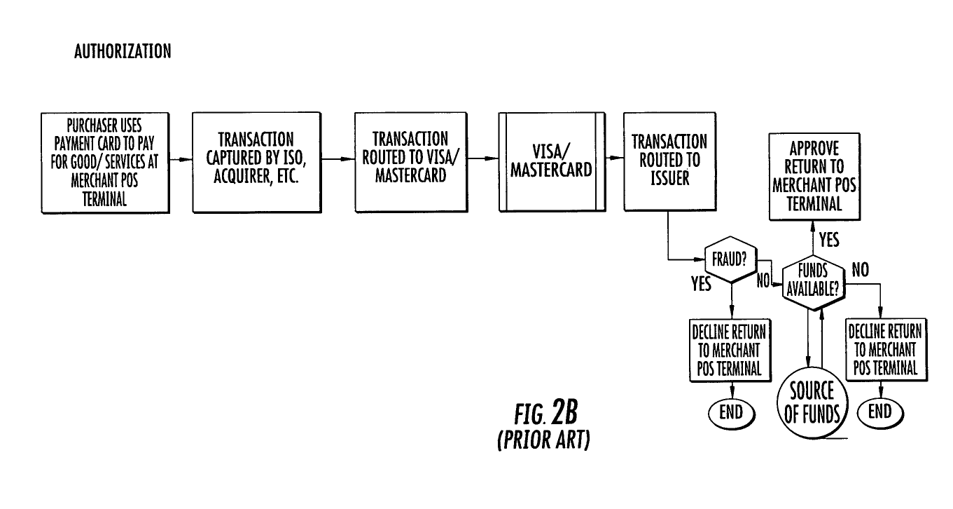

FIG. 2C is a flow diagram of the current industry process for settlement of a VISA/MasterCard transaction

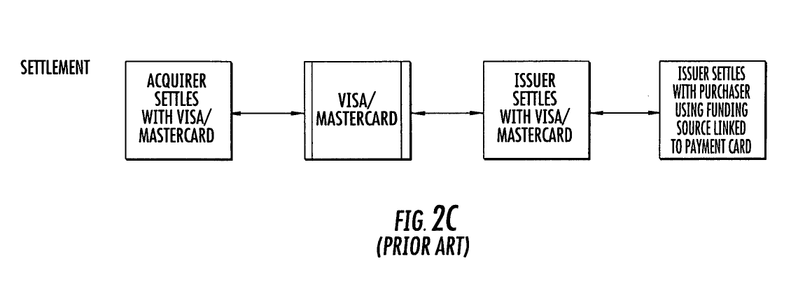

FIG. 3 is a flow diagram of the overall system and method of the present invention.

FIG. 4A is a flow diagram of the authorization process for a pre-purchase funding selection in accordance with the system and method of the present invention.

FIG. 4B is a flow diagram of the settlement process for a pre-purchase funding selection in accordance with the system and method of the present invention.

FIG. 4C is a flow diagram from the perspective of the choice engine for pre-purchase funding selection in accordance with the system and method of the present invention.

FIG. 5A is a flow diagram of the authorization process of a during purchase funding selection in accordance with the system and method of the present invention.

FIG. 5B is a flow diagram of the settlement process of a during purchase funding selection in accordance with the system and method of the present invention.

FIG. 5C is a flow diagram from the perspective of the choice engine for a during purchase funding selection in accordance with the system and method of the present invention.

FIG. 6A is a flow diagram of the authorization process for a post-purchase funding selection in accordance with the system and method of the present invention.

FIG. 6B is a flow diagram of the settlement process for a post-purchase funding selection in accordance with the system and method of the present invention.

FIG. 6C is a flow diagram illustrating the role of the post-purchase pooled available balance in accordance with the present invention.

FIG. 6D is a glow diagram from the perspective of the choice engine for a post-purchase funding selection in accordance with the system and method of the present invention.

FIG. 6E is an illustration of a post-purchase ledger accessible by a purchaser in accordance with the system and method of the present invention.

### DETAILED DESCRIPTION OF THE INVENTION

The following description of the embodiments of the present invention is merely exemplary in nature and is in no way intended to limit the invention, its application, or uses. The present invention is directed to a system and method for electronic funds payment. The present invention has broad potential application and utility, which is contemplated to be adaptable to a wide range of entities. For example, it is contemplated that the system and method of the present invention would be beneficial for use by any payment facilitator including, but without limitation, a bank, credit union, savings and loan, or other entity that provides payment services. Additionally, it is contemplated that the system and method of the present invention would be equally beneficial, for example, for the retail industry. The following description is provided herein solely by way of example for purposes of providing an enabling disclosure of the invention, but does not limit the scope or substance of the invention.

The system and method of the present invention provides a purchaser the ability to make a purchase using a universal payment device at the point of sale (POS) and to select when and how to fund the purchase based upon the preferences of the purchaser. The term “payment device,” as used herein, is any device that facilitates a purchase or a payment on behalf of a purchaser. The term “universal,” as referred to herein in relation to a payment device, refers to a payment device that uses any type of funding source. A benefit delivered to a purchaser as a result of the present invention is the improvement of the experience at POS by eliminating the need to carry multiple forms of payment such as multiple debit and credit cards. Another benefit to the purchaser is the flexibility to decide how to fund a purchase. Still yet another benefit to the purchaser is the ability to make that decision at various points in time relative to the purchase. Thus, an overall advantage of the system and method of the present invention is convenience to a purchaser.

In accordance with the system and method of the present invention, the universal payment device stores information to facilitate a purchase or a payment funded through a funding source in a computer payment network. Facilitation of the payment by the universal payment device at the merchant POS terminal could be, for example, based on the device being a registered debit device (such as with the debit card associations), credit device (such as with the credit card associations), mobile device, or associated with an alternative network (such as ACH or private-label). The merchant terminal may be a physical terminal but also includes, but is not limited to, a virtual terminal, an online terminal, and a terminal accessible by a telephone or other communication device.

The payment device comprises a magnetic-stripe, computer chip, printed card number, switch, or any other means of storing information that is used to facilitate a payment or a purchase at a merchant terminal. The form of the payment device includes, but is not limited to, a card, fob, mobile device, magnetic stripe device, chip device, internet device, wi-fi device, and any other form of device capable of storing information to facilitate a payment at a merchant terminal. Examples of magnetic stripe devices include, but are not limited to, debit card, credit card, charge card, prepaid card, and mini-card. Examples of chip devices include, but are not limited to, contactless card, smart card, mobile phone, fob, watch, PEN, and forehead. Examples of internet devices include, but are not limited to, internet person-to-person payment interfaces, and internet shopping cart. Examples of mobile devices include, but are not limited to, cell phone, personal data assistant (PDA), blackberry, portable music player, and mobile wallets.

The term “computer payment network,” as used herein, is any system which facilitates an electronic payment connecting a payment device with a funding source. Examples include, but are not limited to, Visa, MasterCard, Discover, American Express, Automated Clearing House (ACH), Tempo, PayPal, Regional (PIN), or Private Label store-branded. The system and method of the present invention is not limited to a particular computer payment network.

The term “choice engine,” as used herein, is any system that provides for choice of a funding source to facilitate a purchase or a payment to be made using a payment device.

The term “funding source,” as used herein, is any source that stores value and allows the value to be used to fund a payment or a purchase. Examples include, but are not limited to, checking accounts, prepaid accounts, and lines of credit.

In accordance with the system and method of the present invention, a purchase made with the universal payment device is funded by a funding source. One type of funding source in accordance with the present invention is what is referred to herein as a “pay now” funding source. A “pay now” funding source funds a purchase using a liquid, “funds on hand” funding account. Examples of funding accounts include, but are not limited to, checking account, savings account, money market account, securities account, brokerage account, stored value account, and prepaid account. Another type of funding source in accordance with the present invention is what is referred to herein as a “pay later” funding source. A “pay later” funding source funds a purchase using a credit vehicle. The credit vehicle may be provided by, for example, the issuing bank. Examples of a credit vehicle include, but are not limited to, a secured line of credit and an unsecured line of credit. Examples of a secured line of credit include, but are not limited to, a credit card line of credit, home equity loan, HELOC, and installment loan.

The electronic payment system of the present invention comprises a choice engine. The choice engine provides a purchaser with an option to select a funding source. The choice engine provides the option of selecting a funding source pre-purchase (i.e. before the purchase), during the purchase, post-purchase (i.e. after the purchase), or a combination thereof. The funding source may be a “pay now” or “pay later” funding source.

In accordance with the present invention, the choice engine comprises payment funding options for a purchaser. Pre-purchase funding is governed by rules that control where funds are obtained to support the purchase. Rules are set prior to the purchase being made. Pre-purchase funding rules are set by a payment facilitator, by a purchaser, or by a combination thereof. The funding rules may be set using any communication channel available to the purchaser or the payment facilitator. Examples of communication channels include, but are not limited to, online banking, ATMs, IVR, mobile, and mail. A payment facilitator may set pre-purchase funding rules, for example, as a product feature.

Another purchase option is during purchase funding. During purchase funding is governed by a selection made by the purchaser during the purchase. Purchaser selections could be facilitated with the universal payment device or by the merchant POS device such as an online merchant wallet or debit/credit selection.

Still yet another choice engine option is post-purchase funding. Post-purchase funding is provided by means of a pooled available balance which aggregates the total funds available in the purchaser's various funding sources subject to limitations imposed by the payment facilitator. Individual purchases are posted to a post-purchase ledger awaiting the purchaser's funding choice/decision.

A final funding decision is driven, for example, through the purchaser responding to an immediate prompt from the payment facilitator (such as text message, email, phone call), through the purchaser accessing the post-purchase ledger and providing the payment facilitator with instructions on where funds should be obtained for each purchase, or by application of rules that control where funds are obtained to support the purchase if a purchaser selection was not provided within a set period of time or the pooled available balance was depleted. Purchaser access to the post-purchase ledger could be facilitated via an interface including, but not limited to, a web site, custom mobile computing interface, mobile SMS message/application, ATM, interactive voice response unit (IVR), and paper.

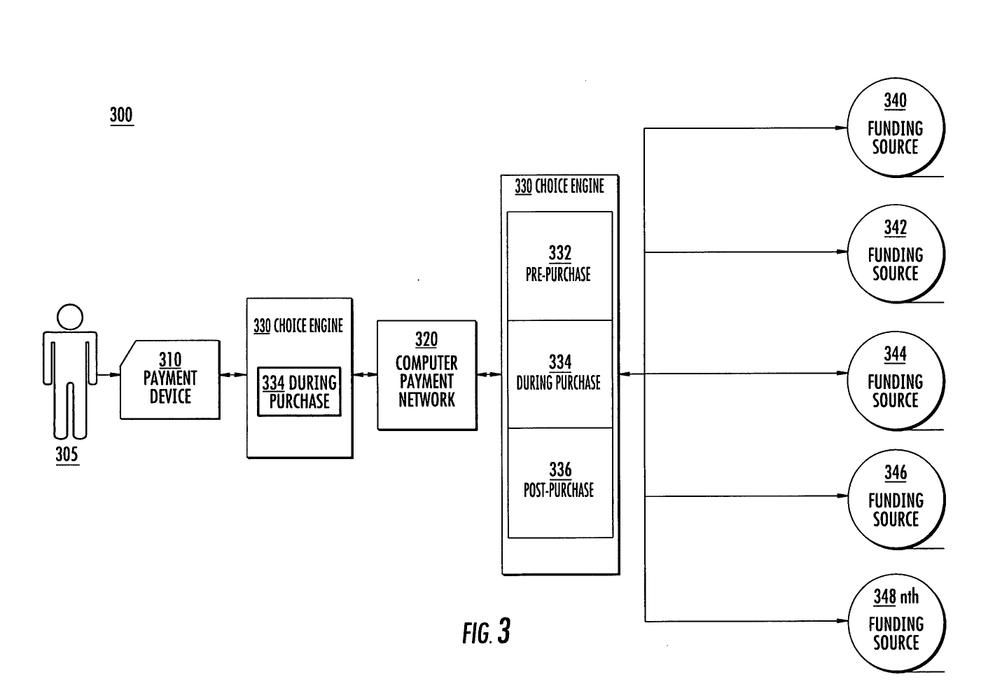

Referring now to the figures, FIG. 3 is a flow diagram illustrating the overall system and method of the present invention. As shown in FIG. 3, the electronic payment system 300 of the present invention comprises a purchaser 305, a universal payment device 310, computer payment network 320, choice engine 330, and a funding source(s) 340-348.

As shown in FIG. 3, a universal payment device 310 is linked to a computer payment network 320. The computer payment network 320 is communicatively connected to a choice engine 330. The choice engine 330 is communicatively connected to a funding source 340. There are up to “n” funding sources where n represents the number of funding sources (as shown in 348). In accordance with the method of the present invention, a purchaser 305 uses a universal payment device 310 to choose a funding source 340-348 using the choice engine 330. Choice engine 330 funding choices comprise pre-purchase funding 332, during purchase funding 334, post-purchase funding 336, or a combination thereof.

With the pre-purchase funding option, rules may be set by a payment facilitator such as a financial institution on behalf of its customer purchaser, for example, or rules may be set by a purchaser through online banking, ATMs, telephone systems such as IVR, mobile wallet, or another application.

With the during purchase option, rules governing the funding of a purchase are determined during the transaction process. A purchaser is prompted for a payment funding selection during the purchase leveraging the merchant terminal, kiosk, shopping cart, or any other device available to the purchaser. Such devices include, but are not limited to, mobile wallets, cell phone, and computer enabled card.

With the post-purchase option, a payment funding selection is made after the purchase. A post-purchase payment is preferably funded via a pooled available balance that consolidates balances from any of the funding sources available to a purchaser. A purchaser selects the available funding source by accessing the post-purchase ledger and decisioning the purchase. The purchaser may access the post-purchase ledger through one of multiple channels. Channels include, but are not limited to, web site, mobile SMS message/application, ATM, and IVR. After a set period of time, non-decisioned purchases are settled against the purchaser's available funding sources based upon rules established by either a payment facilitator or the purchaser using the choice engine.

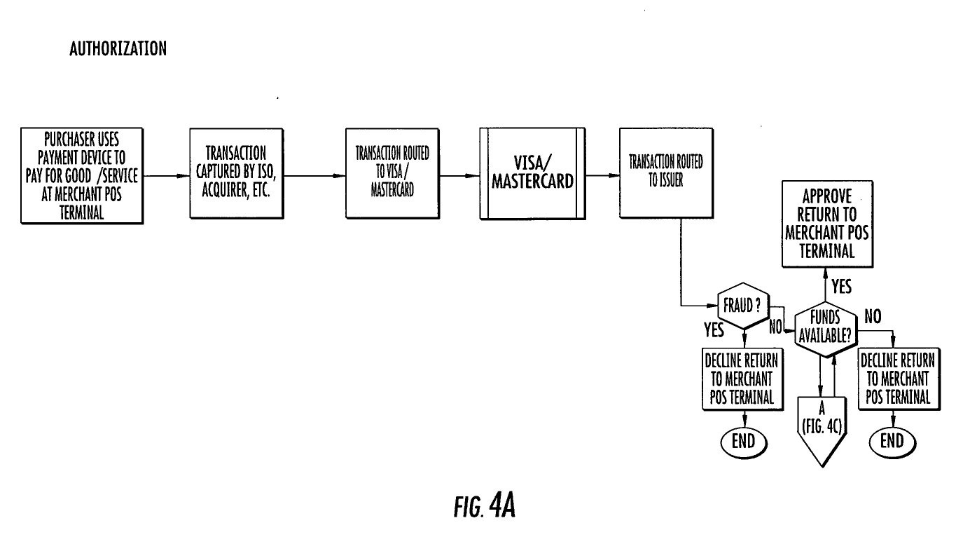

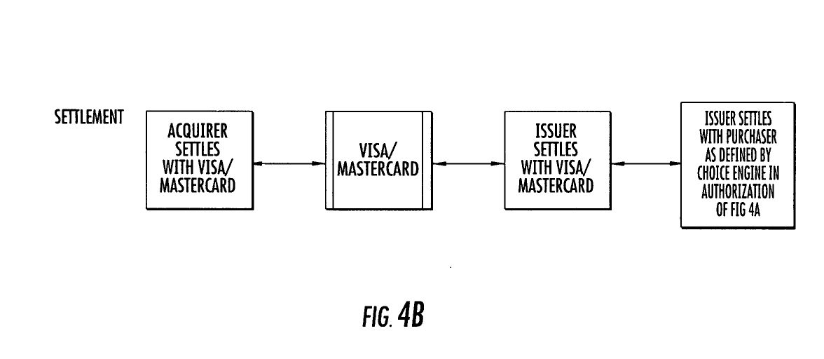

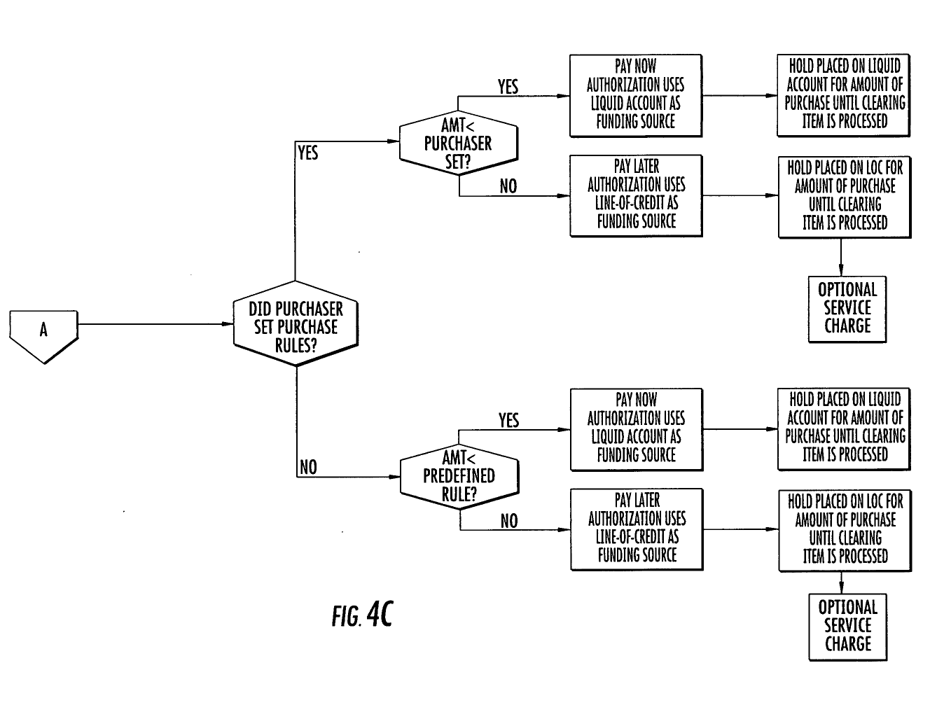

FIGS. 4-6, by way of non-limiting example, illustrate application of the system and method of the present invention to a credit or debit route for a VISA or MasterCard transaction. However, it is within the scope of the present invention that the system and method of the present invention to be applicable, for example, to process flows of other computer payment systems and networks.

Turning now to FIG. 4A, it is a flow diagram that illustrates the authorization process for pre-purchase funding selection in accordance with the system and method of the present invention. In the authorization process, as shown in FIG. 4A, a purchaser uses a universal payment device (such that all payments originate through a universal payment device) to pay for goods or services at a merchant point of sale (POS) terminal. The transaction is captured by ISO or a merchant acquirer. ISO is an independent sales organization that is a reseller of acquirer services. A merchant acquirer is typically a bank member of a card network on behalf of a merchant. The transaction is then routed to VISA/MasterCard by the merchant acquirer. The transaction is then routed to an issuer. The issuer is typically a bank member of a card network that issues payment devices. The issuer approves or denies the transaction based upon specified criteria. For example, the transaction request is checked for fraudulent activity. If there is fraudulent activity associated with the request, the request is declined and returned to the merchant POS terminal. If there is no fraud identified, the available funds are checked by processes which include communication with the choice engine A of FIG. 4C. If the funds are not available, the request is declined and returned to the merchant POS terminal. If the funds are available, the transaction request is approved and returned to the merchant POS terminal.

FIG. 4B is a flow diagram that illustrates the settlement process for pre-purchase, funding selection in accordance with the system and method of the present invention. With respect to the settlement process of FIG. 4B, VISA/MasterCard facilitates settlement between the merchant acquirer and issuer. The merchant acquirer then settles with the merchant. The issuer then settles with the purchaser as defined by the choice engine in the authorization process of FIG. 4A.

FIG. 4C is a flow diagram from the perspective of the choice engine for pre-purchase funding selection in accordance with the system and method of the present invention. In FIG. 4C, the choice engine evaluates whether the purchaser set purchase rules. The purchase rules may include, but are not limited to, a dollar amount, a dollar amount by purchase or budget category (such as, for example, restaurant or gas), and a minimum balance (such as all payments use “pay now” until funds reach a certain amount or exceed a certain type, then use “pay later”). The rules are set prior to purchase by the purchaser using, for example, online banking, ATM, IVR or other bank channel.

For example, if the purchaser set a purchase rule by dollar amount as shown in FIG. 4C, the question is posed as to whether the purchase amount is less than the amount that the purchaser set. If the purchase amount is less than the amount that the purchaser set, then the “pay now” option applies. As shown in FIG. 4C, for example, authorization and/or settlement may use the liquid account as a funding source. A hold is placed on the liquid account for the amount of the purchase until the clearing item is processed. If the purchase option is not less than the amount that the purchaser set, then the “pay later” option applies. As shown in FIG. 4C, for example, authorization and/or settlement may use a line of credit as a funding source. A hold is placed on the line of credit for the amount of the purchase until the clearing item is processed. If the line of credit is used, an optional service charge may apply. The service charge may be built into the process. The service charge may also be waived based upon criteria determined by the issuer.

If the purchaser did not set purchase rules, it defaults to pre-defined rules set by a payment facilitator. The choice engine then uses the pre-defined rules set by the payment facilitator to determine the appropriate funding source (i.e. “pay now” or “pay later”). For example, as shown in FIG. 4C, if the purchase amount is less than the pre-defined set amount, then the “pay now” option applies. As shown in FIG. 4C, for example, authorization and/or settlement may use the liquid account as a funding source. A hold is placed on the liquid account for the amount of the purchase until the clearing item is processed. If the purchase option is not less than the pre-defined set amount, then the “pay later” option applies. As shown in FIG. 4C, for example, authorization and/or settlement may use a line of credit as a funding source. A hold is placed on the line of credit for the amount of the purchase until the clearing item is processed. An optional service charge may apply. The service charge may also be waived based upon criteria determined by the issuer.

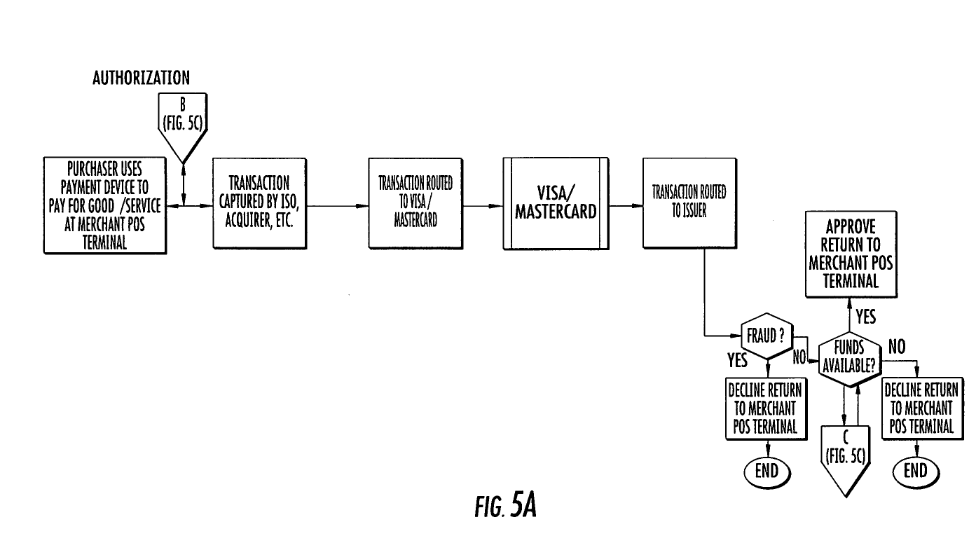

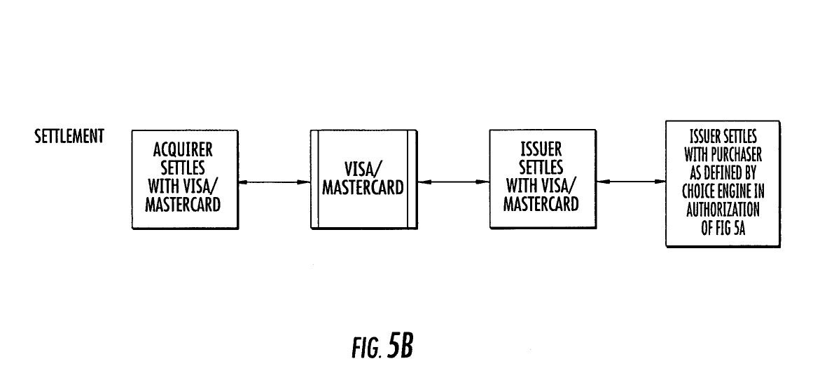

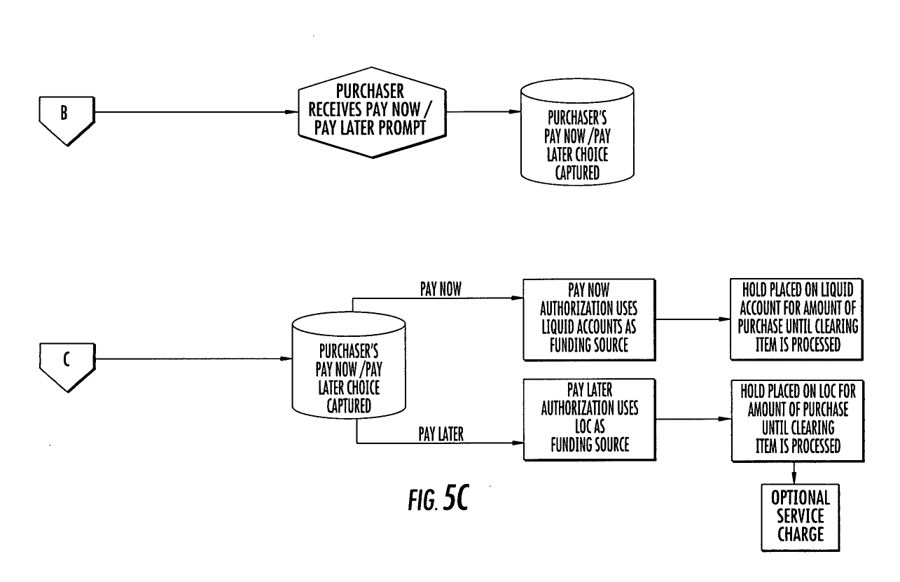

FIG. 5A is a flow diagram of the authorization process of a during purchase payment selection in accordance with the system and method of the present invention. A purchaser uses a payment device to pay for goods or services at a merchant POS terminal. The transaction is routed to the process flow shown in FIG. 5C. FIG. 5C is a flow diagram from the perspective of the choice engine for a during purchase funding selection in accordance with the system and method of the present invention. As shown in FIG. 5C, the purchaser receives a pay now or pay later prompt. The purchaser's pay now or pay later choice is captured in a database. As shown in FIG. 5A, the transaction is captured by ISO or a merchant acquirer. The transaction is routed to VISA/MasterCard. From VISA/MasterCard, the transaction is routed to the issuer. The issuer approves or denies the transaction based upon specified criteria. For example, the transaction request is checked for fraudulent activity. If there is fraudulent activity associated with the request, the request is declined and returned to the merchant POS terminal. If there is no fraud identified, the available funds are checked by processes which include communication with the choice engine C of FIG. 5C. If the funds are not available, the request is declined and returned to the merchant POS terminal. If the funds are available, the transaction request is approved and returned to the merchant POS terminal.

As shown in FIG. 5C, a purchaser's pay now or pay later choice is captured. If the purchaser's choice is pay now, the authorization may use a liquid account as funding source. A hold is placed on the liquid account for the amount of the purchase until the clearing item is processed. If the purchaser's choice is pay later, the authorization may use a line of credit as a funding source. A hold is placed on the line of credit for the amount of the purchase until the clearing item is processed. In the case of a line of credit, an optional service charge may be charged.

FIG. 5B is a flow diagram illustrating the settlement process during purchase funding selection in accordance with the system and method of the present invention. As shown in FIG. 5B, VISA/MasterCard facilitates settlement between the merchant acquirer and issuer. The merchant acquirer then settles with the merchant. The issuer then settles with the purchaser as defined by the choice engine in authorization of FIG. 5A.

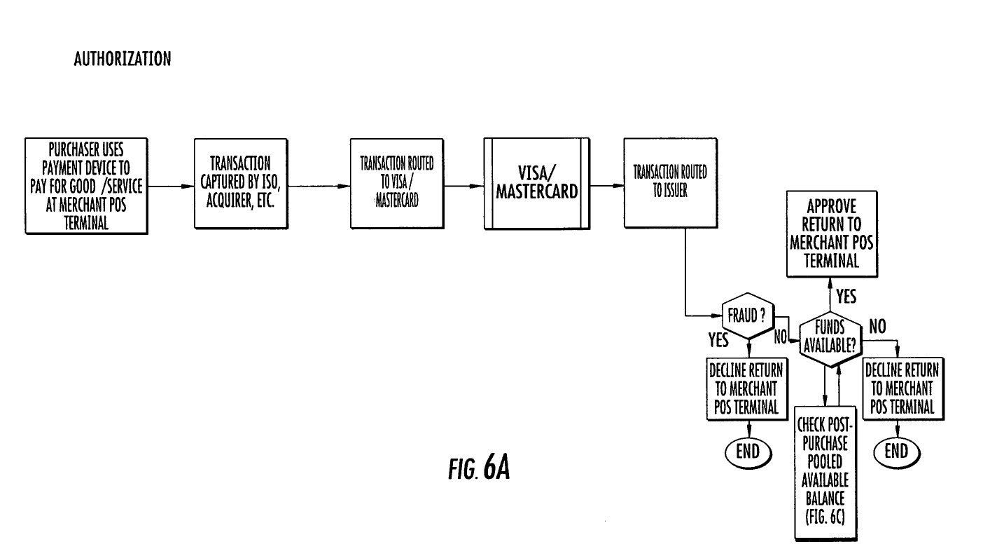

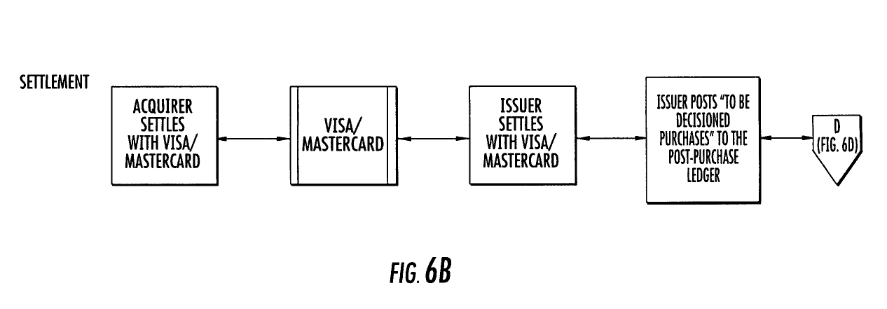

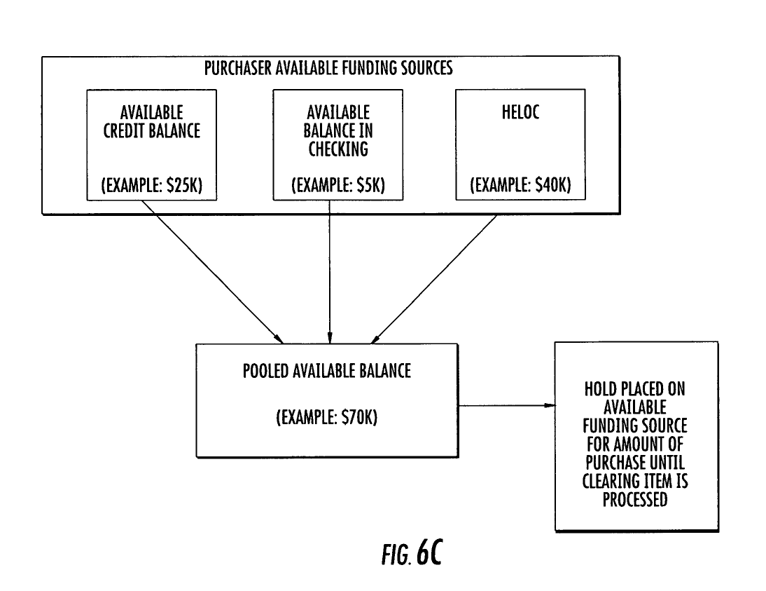

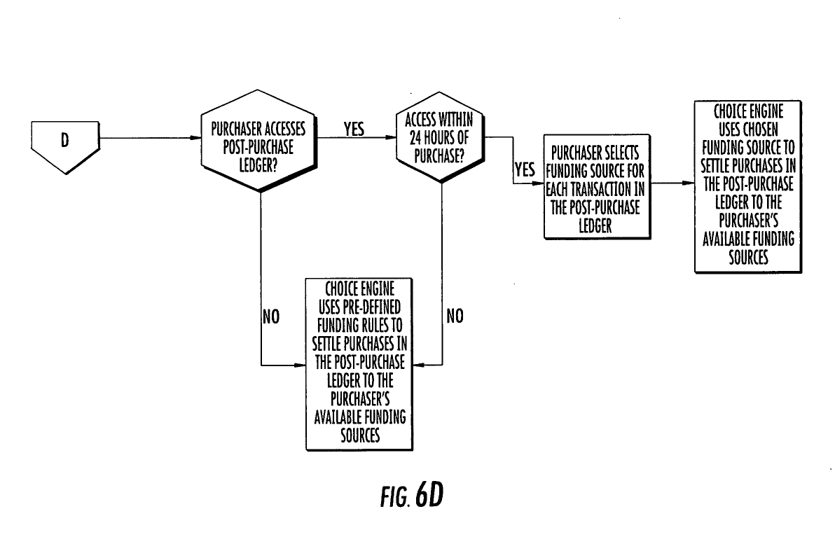

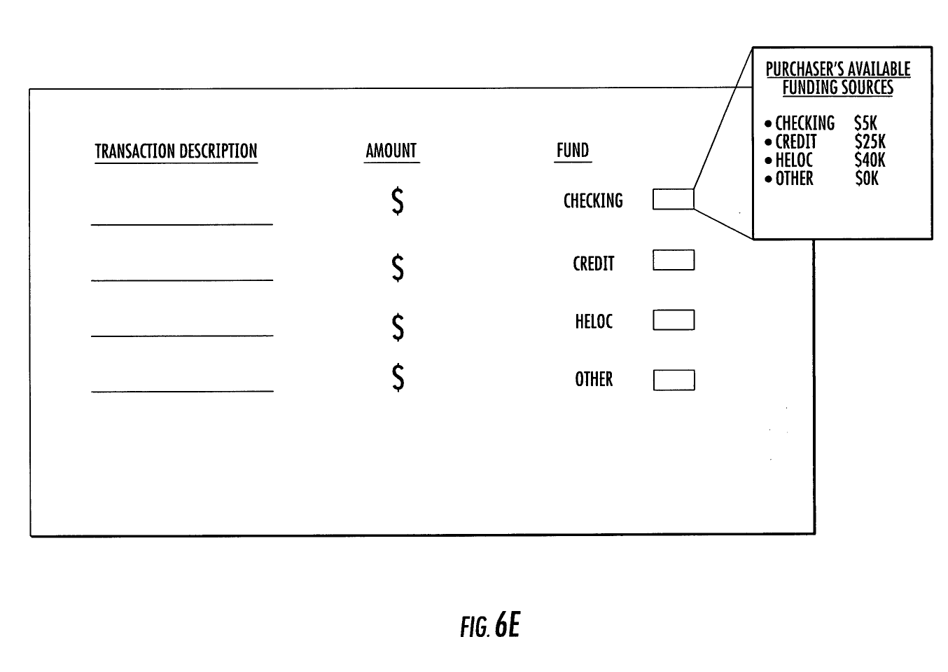

FIG. 6A is a flow diagram illustrating the authorization process for post-purchase funding selection in accordance with the system and method of the present invention. Purchaser uses a universal payment device to pay for goods or services at the merchant POS terminal. The transaction is captured by an ISO, acquirer, or combination thereof. The transaction is routed to VISA/MasterCard. From VISA/MasterCard, the transaction is routed to the issuer. The issuer approves or denies the transaction based upon specified criteria. For example, the transaction request is checked for fraudulent activity. If there is fraudulent activity associated with the request, the request is declined and returned to the merchant POS terminal. If there is no fraud identified, the available funds are checked by processes which include checking the post-purchase pooled available balance as shown in FIG. 6C.

FIG. 6C is a flow diagram illustrating the role of the post-purchase pooled available balance in accordance with the present invention. As shown in FIG. 6C, the pooled available balance is comprised of a number of available funding sources. For example, as shown in FIG. 6C, there may be an available credit balance, an available balance in checking, and a home equity line of credit (HELOC). The pooled available balance is the sum of the monetary amount available from each of these various funding sources. If the funds are not available, the request is declined and returned to the merchant POS terminal. If the funds are available, the transaction request is approved and returned to the merchant POS terminal and the choice engine places a hold on the available funding source.

FIG. 6B is a flow diagram illustrating the settlement process for post-purchase funding selection in accordance with the system and method of the present invention. As shown in FIG. 6B, VISA/MasterCard facilitates settlement between the merchant acquirer and issuer. The merchant acquirer settles with the merchant. The issuer posts the “to be decisioned purchases” to the purchaser's post-purchase ledger.

After the post-purchase ledger is accessed, the process for post-purchase selection in accordance with the system and method of the present invention is shown from the perspective of the choice engine in FIG. 6D. As shown in FIG. 6D, the question is posed as to whether the purchaser accesses the post-purchase ledger. If the purchaser did not access the post-purchase ledger, the choice engine uses pre-set funding rules to settle purchases in the post-purchase ledger to the purchaser's available funding sources. If the purchaser accessed the post-purchase ledger and did so within a set period such as twenty-four (24) hours, the purchaser selects the funding source for each transaction in the post-purchase ledger. The choice engine uses the chosen funding source to settle purchases in the post-purchase ledger to the purchaser's available funding sources.

FIG. 6E is an illustration of a post-purchase ledger accessible by a purchaser in accordance with the present invention. The ledger provides a purchaser with a means to select a funding source. In the example of FIG. 6E, such as viewed from a computer screen of a purchaser, the ledger comprises information such as a transaction description, monetary amount, and list of available funding sources. The list of available funding sources is chosen, for example, by accessing a drop-down menu of funding choices to make it easy and convenient for the purchaser to make a selection. However, the ledger is not limited to the particular configuration shown in FIG. 6E.

Another feature of the system and method of the present invention relates to whether card issuers are prohibited from issuing a card earning credit card interchange rates if that card settles to a funding account within a predetermined time period such as fifteen (15) days or some other criteria pertaining to funding timeframe changes. Applying this to the universal payment device used to initiate payments under the system and method of the present invention is as follows.

The funding timeframe is another feature of the present invention. If the funding time frame for settlement is less than a predetermined time period such as fifteen (15) days or some other criteria pertaining to funding timeframe, the universal payment device may be registered as a debit product and earn debit product interchange for all purchases. In order to make up for lost credit card interchange revenue on pay later purchases, card issuers may opt to charge consumers a fee for pay later purchases.

If the funding time frame for settlement is greater than a predetermined time period or some other criteria pertaining to funding timeframe, the universal payment device may be registered as a credit product and earn credit product interchange for all purchases.

Thus, non-limiting examples of the system and method of the present invention are as follows.

In a first example: the funding timeframe for settlement is less than fifteen (15) days; the funding source is a checking account; the universal payment device interchange earned is debit, and the form of the universal payment device is a card, fob, phone, e-wallet, or watch. Pre-purchase option rules are set by a financial institution based on transaction type or amount, set by the financial institution based on product type or amount, and set by the purchaser. During purchase options are terminal based (i.e. terminal initiated prompting) and device based (i.e. cell phone initiated prompting). Post-purchase options are call prompt for funding choice, ledger access and selection, and pre-defined rule. A pay later fee is optional.

In a second example: the funding timeframe for settlement is greater than fifteen (15) days; the funding source is a credit line; the universal payment device interchange earned is credit; and the form of the universal payment device is card, fob, phone, e-wallet, or watch. Pre-purchase options are rules set by a financial institution based on transaction type or amount, set by the financial institution based on product type or amount, and set by the purchaser. During purchase options are terminal based (i.e. terminal initiated prompting) and device based (i.e. cell phone initiated prompting). Post-purchase options are call prompt for funding choice, ledger access and selection, and pre-defined rule. A pay later fee is optional.

In a third example: the funding timeframe for settlement is at any time; the funding source is a checking account; the universal payment device interchange earned is ACH or some other payment network; and the form of the universal payment device is a card, fob, phone, e-wallet, or watch. Pre-purchase options are rules set by a financial institution based on transaction type or amount, set by the financial institution based on product type or amount, and set by the purchaser. During purchase options are terminal based (i.e. terminal initiated prompting) and device based (i.e. cell phone initiated prompting). Post-purchase options are call prompt for funding choice, ledger access and selection, and pre-defined rule. A pay later fee is optional.

Among the advantages of the present invention are that it provides a purchaser with greater financial control. For example, the present invention allows purchasers to pre-determine their desired spend based upon criteria important to them. This feature enables purchasers, for example, to direct all spending to their credit cards when they are out of funds in their checking account, avoiding overdraft fees, and limit spending based on purchase category or budget category (i.e. only allow $100 per month at fast food locations, then reject transactions). Another advantage is enhanced security. The universal payment device shields other linked accounts from fraud more easily supporting consolidated detection and prevention. Additionally, the purchaser may review a transaction before it posts allowing them to highlight potential fraudulent activity before it impacts their funding sources. Another advantage is convenience to the purchaser. The universal payment device eliminates the need for purchasers to carry multiple-payment devices. Additionally, the purchase experience itself is simplified as purchasers can determine how to fund a transaction after the transaction has been completed.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An electronic payment system comprising:
a choice engine communicatively connected to a computer payment network for electronically providing a purchaser with an option to select a funding source post-purchase.

2. The electronic payment system according to claim 1, wherein the choice engine further comprises the option to select a funding choice during purchase.

3. The electronic payment system according to claim 1, further comprising a universal payment device for use by the purchaser to make the purchase.

4. The electronic payment system according to claim 1, further comprising a ledger for selection of a funding source post-purchase.

5. The electronic payment system according to claim 1, further comprising a pooled available balance of funds.

6. An electronic payment system comprising:
a choice engine communicatively connected to a computer payment network for electronically providing a purchaser with an option to select a funding source pre-purchase and an option to select a funding source post-purchase.

7. The electronic payment system according to claim 6, wherein the choice engine further comprises the option to select a funding choice during purchase.

8. The electronic payment system according to claim 6, further comprising a universal payment device for use by the purchaser to make the purchase.

9. The electronic payment system according to claim 6, further comprising a ledger for selection of a funding source post-purchase.

10. The electronic payment system according to claim 6, further comprising a pooled available balance of funds.

11. A method for electronic payment, the method comprising:
processing of a payment for a purchase made by a purchaser using a choice engine in a computer payment network, wherein the choice engine comprises an option to select a funding source post-purchase.

12. The method according to claim 11, wherein the purchaser uses a universal payment device to make the purchase.

13. The method according to claim 11, wherein the choice engine further comprises the option to select a funding source during purchase.

14. The method according to claim 11, wherein the funding source is a liquid funding account or a credit vehicle.

15. The method according to claim 11, further comprising providing a ledger for selection of the funding source post-purchase.

16. A method for electronic payment, the method comprising:
processing of a payment for a purchase made by a purchaser using a choice engine in a computer payment network, wherein the choice engine comprises an option to select a funding source pre-purchase and an option to select a funding source post-purchase.

17. The method according to claim 16, wherein the purchaser uses a universal payment device to make the purchase.

18. The method according to claim 16, wherein the choice engine further comprises the option to select a funding source during purchase.

19. The method according to claim 16, wherein the funding source is a liquid funding account or a credit vehicle.

20. The method according to claim 16, further comprising providing a ledger for selection of the funding source post-purchase.

21. A method for electronic payment, the method comprising:
processing of a payment for a purchase made by a purchaser using a choice engine in a computer payment network, wherein the choice engine comprises an option to select a funding source pre-purchase, an option to select a funding source during purchase, and an option to select a funding source post-purchase.

22. The method according to claim 21, wherein the purchaser uses a universal payment device to make the purchase.

23. The method according to claim 21, further comprising providing a ledger for selection of the funding source post-purchase.

24. The method according to claim 21, further comprising providing a pooled available balance of funds.

25. The method according to claim 21, wherein the funding source is a liquid funding source or a credit vehicle.
